(19) United States
(12) Patent Application Publication
(10) Pub. No.: US 2023/0102537 A1
(43) Pub. Date: Mar. 30, 2023

(54) Surgical Model

(71) Applicant: DJO, LLC, CARLSBAD, CA (US)

(72) Inventor: Donald P. LoGuercio, Scottsdale, AZ (US)

(73) Assignee: Outcome-Based Technologies LLC, Cheyenne, WY (US)

(21) Appl. No.: 17/448,014

(22) Filed: Sep. 17, 2021

(51) Int. Cl. G09B 23/32

(52) U.S. Cl. CPC G09B 23/32

(57) ABSTRACT

A surgical model includes a first body corresponding to an ilium, the first body including a socket, a ridge around the socket, and a key in the ridge mounted to the first body for movement with respect to the ridge. The model includes a second body corresponding to a femur, the second body terminating in a head corresponding to a femoral head, wherein the head is received in the socket for movement of the second body in a plane of movement. A block is mounted for movement in the second body, and is located for confrontation with the key when the second body moves in the plane of movement. The key and block move between first and second positions. The first positions disable a full range of movement of the second body in the plane of movement, and the second positions enable the full range of movement.

### FIELD

The present specification relates generally to medicine, and more particularly to medical educational and demonstration tools.

### BACKGROUND

Hip surgeries represent a large and growing percentage of surgeries performed in the United States. They are major procedures, requiring hours of anesthesia, prolonged traction, and surgical replacement or repair of bone, muscle, and other tissues. For the patient, hip surgeries can be a frightening prospect.

As part of pre-operative education, a surgeon will explain a surgical procedure to the patient. Some doctors rely just on oral descriptions, while some use handouts and flyers. Others may show patients three-dimensional video renderings. However, explanations are made easier when a patient can see, touch, and hold the object being described. A surgical model can greatly enhance a patient’s understanding of a surgical procedure and help him or her become much more comfortable with it.

### SUMMARY

A surgical model including a first body corresponding to an ilium, the first body having a socket corresponding to an acetabulum, a ridge around the socket corresponding to a lunate surface of the acetabulum, and a key in the ridge mounted to the first body for movement with respect to the ridge. The surgical model has a second body corresponding to a femur, the second body terminating in a head corresponding to a femoral head, wherein the head is received in the socket for movement of the second body in at least a plane of movement. A block or shaft is mounted for movement in the second body, wherein the block is located in the second body for confrontation with the key when the second body moves in the plane of movement. The key and block each move between first and second positions. The first positions of the key and block disable a full range of movement of the second body in the plane of movement, and the second positions of the key and block enable the full range of movement.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIGS. 1A and 1B are front and rear perspective views of a surgical model, showing a body corresponding to a femur, and a shaft in the body arranged in a first position, wherein the body is in a lowered position;

FIG. 1C is a front perspective view of the surgical model showing the body corresponding to the femur in a raised position;

FIGS. 2A and 2B are section views taken along the line 2-2 in FIG. 1A, showing a shaft in the body in first and second positions, respectively;

FIGS. 3A and 3B are front and rear perspectives, with the shaft arranged in a second position, showing the body in the lowered position; and

FIG. 3C is a front perspective view of the surgical model, with the shaft arranged in a second position, enabling movement of the body into a higher raised position.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

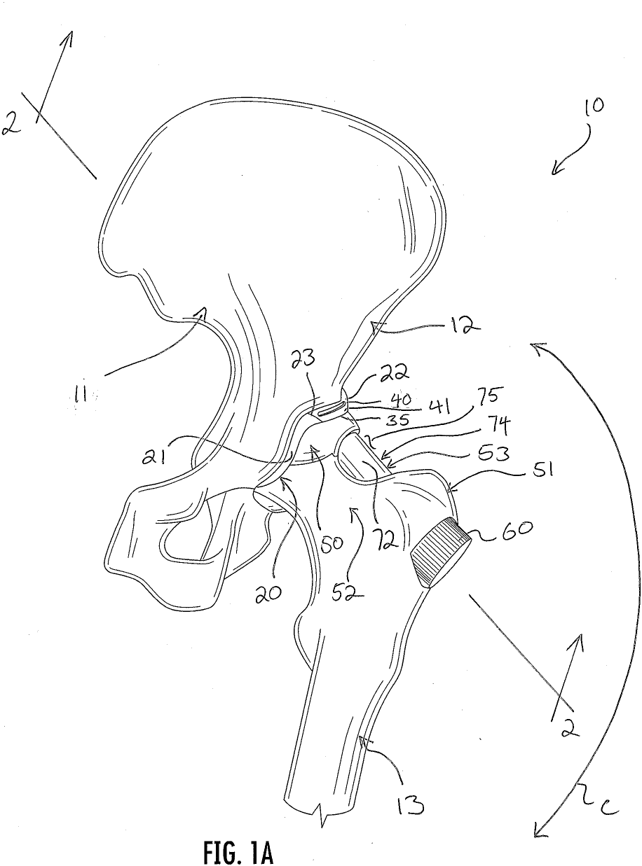

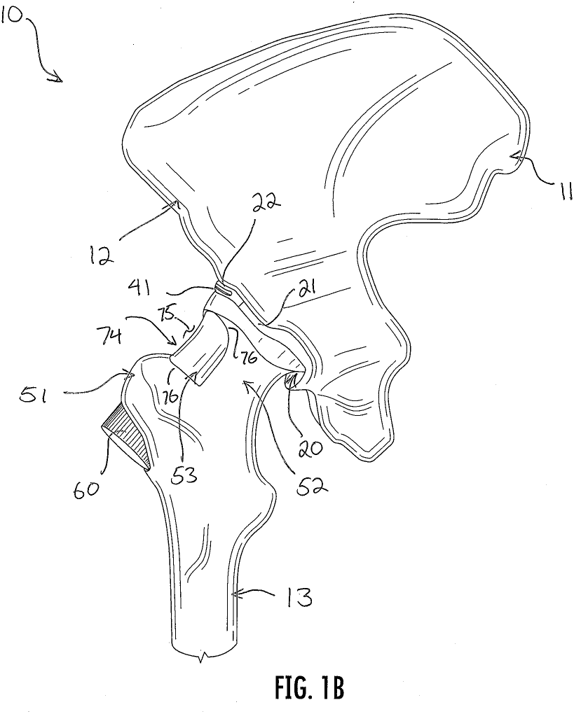

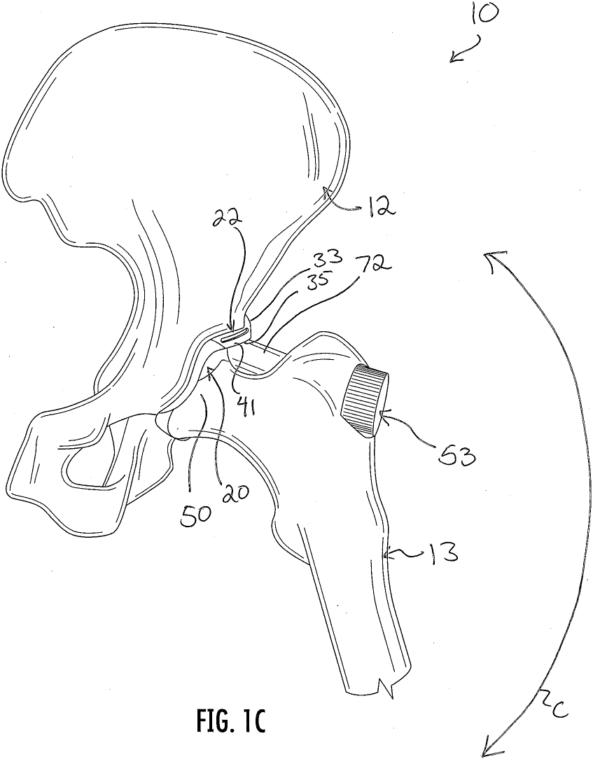

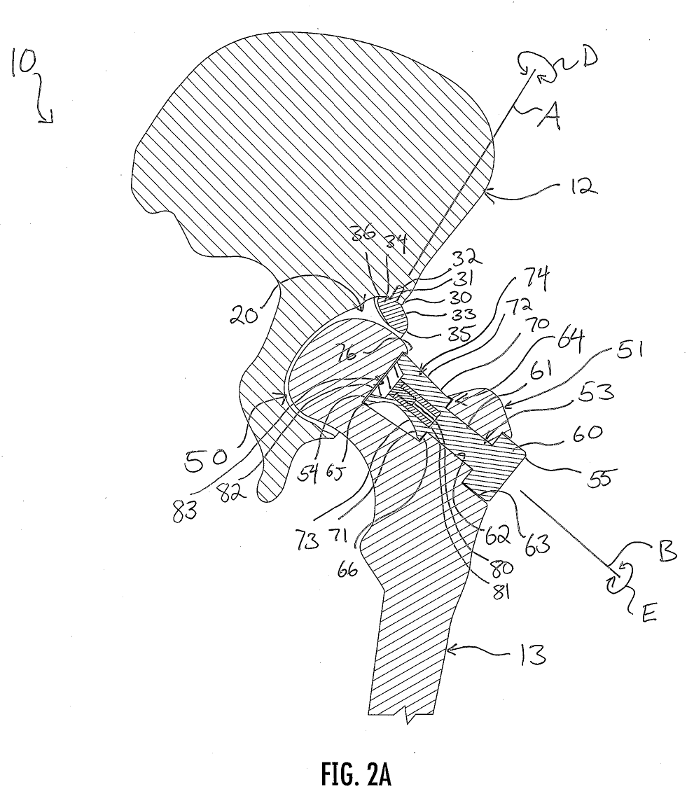

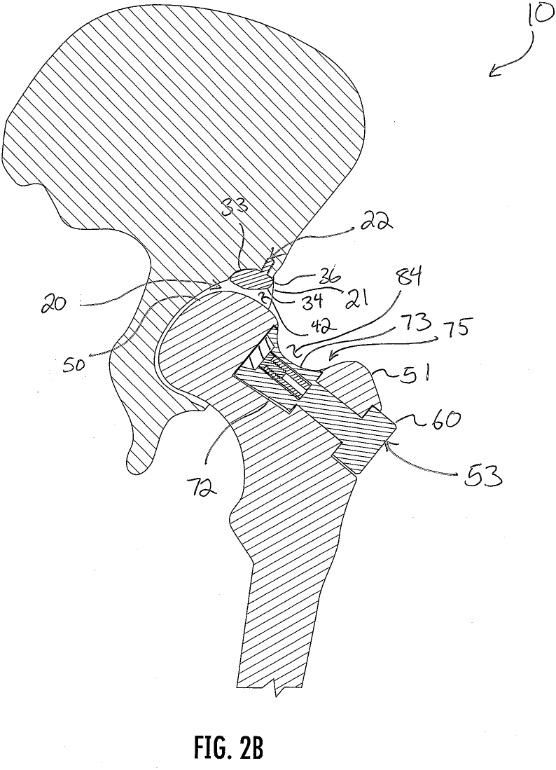

FIGS. 1 and 2 are front and rear perspective views of a surgical model 10. The model 10 corresponds to a human hip joint, and the structural elements and features of the model 10 correspond to the different anatomical structures and features of a human hip joint. As such, much of the description herein refers to elements and features of the model 10 with corresponding anatomical names. The reader should nevertheless understand that the model 10 is only a demonstration model, not an anatomical assembly. For example, the model 10 includes a major body 11 corresponding to a pelvis, and within this description, the major body 11 is alternately referred to as a “pelvis 11” for the sake of clarity of the description. The pelvis 11 includes a first body 12 corresponding to an ilium 12, which forms the upper portion of the pelvis 11. Connected to the ilium 12 is a second body 13, corresponding to a femur 13. The femur 13 moves with respect to the ilium 12 in a manner that mimics movement of an actual femur with respect to an actual ilium.

The ilium 12 includes a socket 20, a ridge 21 around the socket 20, and a key 22 in the ridge 21. The socket 20 corresponds to an acetabulum 20, which is the anatomical socket of the pelvis that receives the femur. The ridge 21 defines the outer edge of the concave socket 20, directed outwardly away from the ilium 12. The ridge 21 is a thin projection at the socket 20. The ridge 21 extends substantially around most of the socket 20. The top of the ridge 21 is formed with a notch 23 which severs the ridge 21. The notch 23 is a small cavity, and the key 22 is mounted in this cavity.

Referring now to FIGS. 1A and 1B but also to the section view of FIG. 2A, the key 22 is mounted for rotation along an axis A. The key 22 includes a head 30 and a shank 31 projecting integrally from the head 30. That shank 31 is set into a bore 32 within the ilium 12. The shank 31 is threadably received in the bore 32, though in other embodiments, the shank 31 is snugly mounted, or mounted in a bearing fit in the bore 32. The shank 31 is formed integrally to the head 30, and the head 30 is disposed in the socket 20 at the ridge 21.

They key 22 rotates around the axis A which extends through the shank 31. The key 22 is an eccentric, as the shank 31 does not extend from a geometric center of the head 30. Rather, the head 30 has opposed first and second lobes 33 and 34 on either side of the shank 31, and the first lobe 33 is larger than the second lobe 34. The first lobe 33 is approximately three to four times larger in volume than the second lobe 34. The first lobe 33 terminates opposite the second lobe 34 in a first edge 35, and the second lobe 34 terminates opposite the first lobe 33 in a second edge 36.

The first lobe 33 has an elongate slot 40 formed inboard of the first edge 35. In this context, “inboard” means inside of the first edge 35, or set back form the first edge 35 on the first lobe 33, or disposed slightly toward the second edge 36 in contrast with being disposed at or on the first edge 35. In this location, the slot 40 defines a thin band 41 of material between the slot 40 and the first edge 35. In some embodiments, this thin band 41 of material is flexible and durable, while in other embodiments it is rigid.

As can be seen best in FIG. 2A, the first edge 35 is lower than the second edge 36 with respect to the axis A. In other words, the first edge 35 is closer to the bottom of the pelvis 11 along the axis A than is the second edge 36. The first edge 35 is directed radially outward from the axis A and also slightly downward: a line drawn from the union of the shank 31 and the head 30 to the first edge 35 is oriented in this direction. The second edge 36 is directed radially outward from the axis A but slightly upward: a line drawn from the union of the shank 31 and the head 30 to the second edge 36 is oriented in this direction.

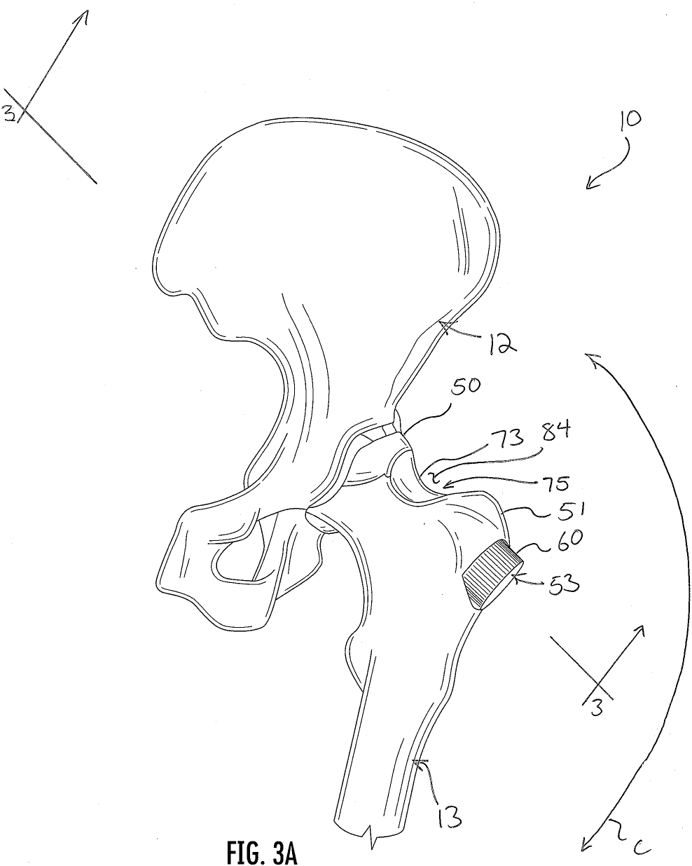

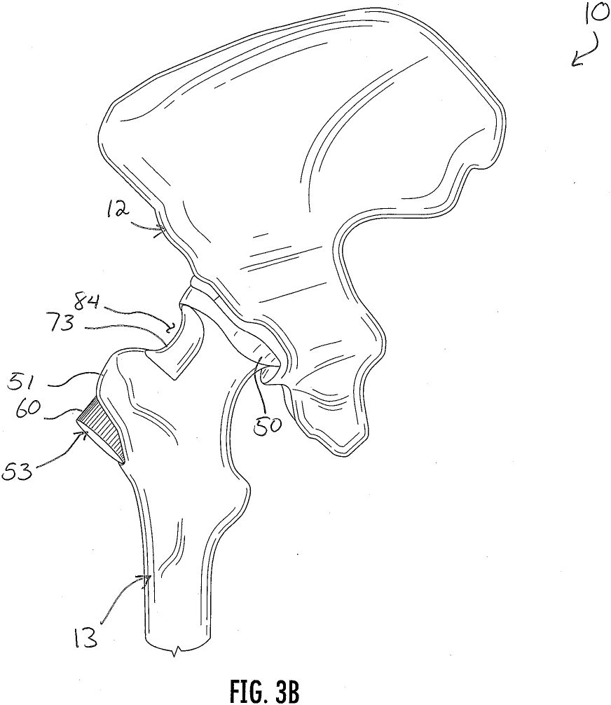

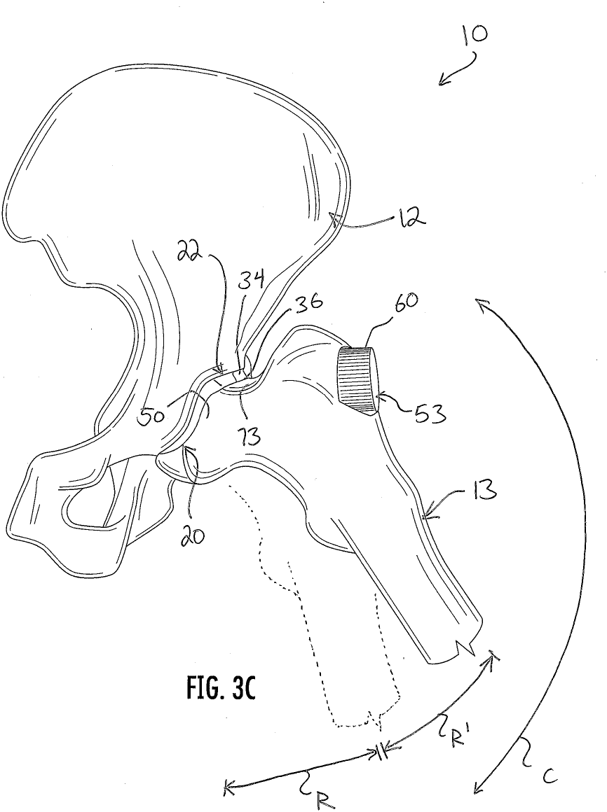

The key 22 rotates to move the first and second lobes 33 and 34 into and out of the socket 20. FIGS. 1A-2A show a first position of the key 22, while FIGS. 2B-3C show a second position of the key 22. In the first position of the key 22, the first lobe 33 is partially out of the socket 20 and the second lobe 34 is entirely within the socket 20. The first lobe 33 projects out of the socket 20, such that the slot 40 and the band 41 are both outside of the ilium 12. The first edge 35 is registered with the ridge 21 such that the first edge 35 is a contiguous extension of the ridge 21 in the notch 23. The surfaces of the ridge 21 and first lobe 33 are contiguous to each other and present common surfaces interrupted only by the seam or slight separation between the key 22 and the ridge 21.

In the first position of the key 22, the second lobe 34 is directed into the socket 20. The key 22 rotates, however, to the second position to direct the second lobe 34 away from the socket 20, even while both the first and second lobes 33 and 34 remain within the socket 20. Turning now to FIG. 2B, which is a section view taken along the line 3-3 in FIG. 3A, the key 22 is shown rotated into the second position. In this second position, the first lobe 33 is directed into the socket 20, away from the outside, and the second lobe 34 is directed out of the socket 20. However, the second lobe 34 is small and so does not extend out of the socket 20. The second edge 36 is thus inboard of the ridge 21 when the key 22 is in this second position. As can be seen in FIG. 2B, both the second edge 36 and the ridge 21 can be seen because the former is short of the latter.

Comparing the position of the first edge 35 in the first position of the key 22 with the position of the second edge 36 in the second position of the key 22 shows that the second position reveals a gap 42 between the key 22 and the femur 13. This gap 42 helps accommodate movement of the femur 13 with respect to the ilium 12.

With reference now to FIGS. 1A-1C, the femur 13 terminates in a large head 50 corresponding to a femoral head. The femur 13 further includes a pronounced ridge 51 corresponding to a greater trochanter. The head 50 and ridge 51 are spaced apart by a neck 52 corresponding to the femoral neck between the femoral head and the greater trochanter. The neck 52 is a valley between the head 50 and ridge 51.

A block or shaft 53 is mounted in the femur 13 between the head 50 and the ridge 51, extending through the neck 52. The shaft 53 is preferably mounted for rotational movement about a longitudinal axis B, best shown in FIG. 2A. The axis B is transverse, or not parallel, to the axis A of the key 22. The shaft 53 has two sides which are each disposed in the neck 52 and can be arranged between different positions to change the geometry of the femur 13 and thereby help accommodate different ranges of movement of the femur 13 with respect to the ilium 12. In at least one position, the shaft 53 enables a full range of movement of the femur 13, while in at least another position, the shaft 53 disables that full range of movement, thereby blocking or limiting the movement of the femur 13. For this reason, the shaft 53 is also referred to herein as a block. In other embodiments, the shaft 53 has shapes, mountings, movements, and arrangements other than as described herein, but to the extent that shaft 53 enables and disables movement of the femur 13 through a full range of motion, such other embodiments are included within the scope of this disclosure. For instance, in other embodiments, the block or shaft 53 translates to assume different positions and change the geometry of the femur 13.

As shown in FIG. 2A, the shaft 53 includes a first, inner end 54 and a second, outer end 55. The shaft 53 has a knob 60 at its outer end 55. The knob 60 is an enlarged head, preferably formed with knurling or other textured surface to enhance grip on the knob 60. The knob 60 is partially outside of the femur 13 so that a person may grab and turn the knob 60, so as to impart rotation to the entire shaft 53.

The knob 60 is integrally and monolithically formed to a shank 61. The shank 61 is carried in a bore 62 through the ridge 51. The bore 62 terminates in an open socket 63 in which the knob 60 is located and available to be grasped and turned.

The shank 61 is integrally and monolithically formed to a confrontation head 64. The confrontation head 64 has a first end 65 and an opposed second end 66. The first end 65 is also the first end 54 of the shaft 53. The confrontation head 64 is generally conical, with an outer diameter that increases slightly from the second end 66 to the first end 65. The first and second ends 65 and 66 themselves are flat and normal to the axis B. The second end 66 also has a diameter which is larger than the outer diameter of the shank 61 and which is slightly smaller than the outer diameter of the knob 60.

The confrontation head 64 includes first and second sides 70 and 71, shown opposite each other in FIG. 2A. Each side presents a surface; the first side presents a first confrontation surface 72 and the second side presents a second confrontation surfaces 73. The first side 70 is a portion of the conical shape of the confrontation head 64 which is conical, or a portion thereof, without interruptions, projections, depressions, or other discontinuities, and so the first confrontation surface 72 has a semi- or quasi-conical surface which extends around only a portion, or side, of the confrontation head 64. The second side 71, however, is recessed or eroded with respect to the confrontation head 64. The second side 71 has a concave depression extending into the body of the confrontation head 64, thereby forming a cavity which, as described below, defines a keyway for the key 22 in certain arrangements of the model 10.

The second confrontation surface 73 on this second side 71 extends nearly entirely from the first end 65 to the second end 66 of the confrontation head 64, and is smooth, arcuate, and formed without interruptions, projections, depressions, or other discontinuities. The second confrontation surface 73 is concave such that it extends nearly to the middle of the confrontation head 64.

The block or shaft 53 is preferably mounted for rotation in the femur 13. The shank 61 and knob 60 are carried in the bore 62. Axially registered with that bore 62, and formed in open communication with it, is a socket 74 in the neck 52. The socket 74 is slightly conical, corresponding to the shape of the confrontation head, and the socket 74 has a window 75. The window 75 is an opening of the socket 74 to the exterior, where the confrontation head 64 is exposed. The socket 74 projects slightly beyond the window 75 along the axis B in both directions, forming small overhanging ledges or lips 76 in the femur 13 that encircle the first and second ends 65 and 66 of the confrontation head 64 and hold the confrontation head 64 in place during rotation and prevent movement away from the axis B.

The shaft 53 is mounted for rotation with respect to and over an axle 80 secured in the head 50. A sleeve 81 is fit over the axle 80 and threadably engaged thereto. The axle 80 is secured in the head 50 and projects through a truncated conical base 82. The base 82 is located proximate the first end 65, and the sleeve 81 extends from proximate the base 82 to the second end 66. The axle 80, sleeve 81, and base 82 are disposed within the shaft 53, in a generally cylindrical hold 83 that is aligned with and registered over the axis B. The hold 83 receives the axle 80, sleeve 81, and base 82 in a close-fit arrangement allowing the confrontation head 64 to spin within the hold 83. The confrontation head 64 is formed integrally to the shank 61 and the knob 60, such that rotating the knob 60 imparts rotation to the confrontation head 64. The shaft 53 thusly moves between a first position, as shown in FIG. 2A, and a second position, as shown in FIG. 2B.

In the first position of the shaft 53, shown in FIG. 2A, the first confrontation surface 72 is disposed in the window 75 and the second confrontation surface 73 is directed away from the window 75. The first confrontation surface 72 extends from the ridge 51 to the head 50 and presents a regular, straight conical surface therebetween. The first confrontation surface 72 is a linear interruption between the ridge 51 and the head 50. In the first position of the shaft 53, the first confrontation surface 72 corresponds roughly to a femoral neck in need of repair.

The first confrontation surface 72 confronts and impinges the key 22 when the femur 13 moves with respect to the ilium 12, thereby limiting the range movement of the femur 13. In FIG. 1A, the femur 13 is shown down, in a lowered or neutral position. The femoral head 50 is fit within the socket 20 but is rotated down in the socket 20, too, such that an upper position of the head 50 is visible. The first confrontation surface 72 is exposed in the window 75 and is spaced apart from the key 22.

When the femur 13 is moved upward along the double-arrowed line C in FIG. 1A to a raised position, however, the first confrontation surface 72 is moved into a confronting relation with the key 22. FIG. 1C shows the raised or flexed position of the femur 13. The femoral head 50 remains fit within the socket 20 but is rotated up, and the upper portion of the head 50 is now within the socket 20. Moreover, first confrontation surface 72 impacts the first edge 35 of the first lobe 33 of the key 22, thereby preventing further movement along the arcuate line C. The arcuate line C defines a plane of movement; when the key 22 is in the first position and the shaft 53 is in the first position, the interaction of the key 22 and first confrontation surface 72 disables a full range of movement of the femur 13 in that plane of movement. This corresponds to the limited mobility a patient requiring hip surgery may present at a doctor’s office.

In the first position of the key 22 and shaft 53, and in the raised position of the femur 13, the first confrontation surface 72 impacts the first edge 35 of the key 22. In embodiments in which the band 41 is flexible and durable, the shaft 53 softly impacts the key 22 and budges or yields just slightly. In embodiments in which the band 41 is rigid, the shaft 53 impacts the key 22 and the key 22 does not yield. In all embodiments, the model displays the limited mobility of a pre-operative hip patient.

However, the model 10 is also effective at demonstrating to a patient the full range of movement possible after surgery. Turning to FIGS. 2A and 2B, rotating both the key 22 and the shaft 53 from their first positions (FIG. 2A) to their second positions (FIG. 2B) reconfigures the model 10 to correspond to a post-operative state in which the femur 13 may be moved through a full range of movement.

Rotating the key 22 as indicated by the circular arrowed line D in FIG. 2A moves the orientation of the first and second lobes 33 and 34. Rotating the key 22 one-hundred eighty degrees about the axis A reverses the orientation of the key 22 from the first position of FIG. 2A to the second position of FIG. 2B. In the second position of the key 22, the first lobe 33 is within the socket 20 and the second edge 36 of the second lobe 34 is inboard of the ridge 21, thereby forming the gap 42 below the key 22.

Next, rotating the shaft 53 as indicated by the circular arrowed line E in FIG. 2A moves the orientation of the first and second confrontation surfaces 72 and 73. Grasping the knob 60 and rotating the shaft 53 one-hundred eighty degrees about the axis B reverses the orientation of the shaft 53 from the first position of FIG. 2A to the second position of FIG. 2B.

In the second position of the shaft 53, the second confrontation surface 73 is exposed in the window 75, and the first confrontation surface 72 is directed away from the window 75. The second confrontation surface 73 extends entirely from the ridge 51 to the femoral head 50 but does so in an arcuate fashion. Because the second confrontation surface 73 is concave, it defines a sloping U-shaped transition between the surface of the ridge 51 and the surface of the head 50, as seen in the front and rear perspective views of FIGS. 3A and 3B. The second confrontation surface 73 is recessed or eroded with respect to the first confrontation surface 72, as it is receded back and closer to the middle of the shaft 53 than is the first confrontation surface 72. It defines a keyway 84, which is the open void defining the volume between the second confrontation surface 73 and the location of the first confrontation surface 72 when the shaft 53 is in the first position thereof. This keyway 84 receives the key 22 when the femur 13 moves. When the shaft 53 is in the second position, the second confrontation surface 73 corresponds roughly to a repaired femur 13 providing a patient with a greater range of movement.

Like the first confrontation surface 72, the second confrontation surface 73 confronts and impinges the key 22 when the femur 13 moves with respect to the ilium 12, limiting the range of the movement of the femur 13. However, the second confrontation surface 73 confronts and impinges the key 22 only after a much larger range of movement of the femur than does the first confrontation surface 72, and one which corresponds to normal movement of an actual femur. In other words, the second positions of the key 22 and the shaft 53 enable a full range of movement of the femur 13, much larger than the range of movement in the second positions of the key 22 and the shaft 53.

When the key 22 and the shaft 53 are in the second positions thereof, and the femur 13 is in the lowered position of FIG. 3A, the femoral head 50 is fit within the socket 20 but is rotated down in the socket 20, such that an upper portion of the head 50 is visible. The second confrontation surface 73 is exposed in the window 75 and is spaced apart from the key 22.

When the femur 13 is then moved upward along the double-arrowed line C in FIG. 3A to a raised position, the second confrontation surface 73 eventually impacts the key 22. FIG. 3C shows the raised or flexed position of the femur 13. The femoral head 50 remains fit within the socket 20 but is rotated up, and the upper portion of the head 50 is how within the socket 20. Moreover, the second confrontation surface 73 impacts the second edge 36 of the second lobe 34 of the key 22, thereby preventing further movement along the arcuate line C. When the key 22 is in its second position and the shaft 53 is in its second position, the interaction of the key 22 and second confrontation surface 73 enables a full range of movement of the femur 13 along the plane of movement defined by the arcuate line C. This corresponds to the improved mobility of a patient after surgery.

FIG. 3C shows in broken line the raised position of the femur 13 when the key 22 and the shaft 53 are each in the first positions thereof. The arcuate line R indicates the range of movement possible when the key 22 and shaft 53 are in the first positions. In other words, the arcuate line R shows the range of movement from the lowed position of the femur 13 to the raised position when the full range of movement is disabled. The arcuate line R′, however, indicates the additional range of movement possible when the key 22 and the shaft 53 are each in the second positions. In other words, the arcuate lines R and R′, together, show the extent of movement from the lowered position of the femur 13 to the raised position when the full range of movement is enabled. Moving both the key 22 and the shaft 53 from their first to second positions enables this full range of movement, which is approximately twice as large as the limited range shown just by the line R. This corresponds to the increased, full range of motion a patient experiences after surgery.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A surgical model comprising:
a first body corresponding to an ilium, including a socket corresponding to an acetabulum, a ridge around the socket corresponding to a lunate surface of the acetabulum, and a key in the ridge mounted to the first body for movement with respect to the ridge;
a second body corresponding to a femur, the second body terminating in a head corresponding to a femoral head, wherein the head is received in the socket for movement of the second body in at least a plane of movement;
a block mounted for movement in the second body, wherein the block is located in the second body for confrontation with the key when the second body moves in the plane of movement; and What is claimed is:
the key and block each move between first and second positions, wherein the first positions of the key and block disable a full range of movement of the second body in the plane of movement, and the second positions of the key and block enable the full range of movement.

2. The surgical model of claim 1, wherein the key is mounted for rotational movement along an axis.

3. The surgical model of claim 2, wherein the block is mounted for rotational movement along a longitudinal axis.

4. The surgical model of claim 3, wherein the longitudinal axis is transverse to the axis.

5. The surgical model of claim 1, wherein the key includes a first edge which is registered with the ridge when the key is in a first position, and a second edge which is inboard of the ridge when the key is in a second position.

6. The surgical model of claim 1, wherein the block includes a first side having a first confrontation surface and a second side having a second confrontation surface, wherein the second confrontation surface is recessed with respect to the first confrontation surface.

7. The surgical model of claim 1, wherein the block terminates in a knob outside of the second body.

8. A surgical model comprising:
a first body corresponding to an ilium, including a socket corresponding to an acetabulum, a ridge around the socket corresponding to a lunate surface of the acetabulum, and a key in the ridge mounted to the first body for movement with respect to the ridge;
a second body corresponding to a femur, the second body terminating in a head corresponding to a femoral head, wherein the head is received in the socket for movement of the second body in at least a plane of movement; and
a block mounted for movement in the second body, wherein the block is located in the second body for confrontation with the key when the second body moves in the plane of movement.

9. The surgical model of claim 8, wherein the block includes a longitudinal axis and is mounted for rotational movement about the longitudinal axis.

10. The surgical model of claim 8, wherein the key is mounted for rotational movement along an axis transverse to the longitudinal axis of the block.

11. The surgical model of claim 8, wherein the key includes a first edge which is registered with the ridge when the key is in a first position, and a second edge which is inboard of the ridge when the key is in a second position.

12. The surgical model of claim 8, wherein the block includes a first side having a first confrontation surface and a second side having a second confrontation surface, wherein the second confrontation surface is recessed with respect to the first confrontation surface.

13. The surgical model of claim 8, wherein the key and block each move between first and second positions, wherein the first positions of the key and block disable a full range of movement of the second body in the plane of movement, and the second positions of the key and block enable the full range of movement.

14. The surgical model of claim 8, wherein the block terminates in a knob outside of the second body.

15. A surgical model comprising:
a first body corresponding to an ilium, including a socket corresponding to an acetabulum, a ridge around the socket corresponding to a lunate surface of the acetabulum, and a key in the ridge mounted to the first body for movement with respect to the ridge;
a second body corresponding to a femur, the second body terminating in a head corresponding to a femoral head, wherein the head is received in the socket for movement of the second body in at least a plane of movement;
a block mounted for movement in the second body, the block including a first side having a first confrontation surface and a second side having a second confrontation surface, wherein the second confrontation surface is recessed with respect to the first confrontation surface;
the key and block each move between first and second positions, wherein:
the first positions of the key and the block disable a full range of movement of the second body in the plane of movement; and
the second positions of the key and the block enable the full range of movement of the second body in the plane of movement.

16. The surgical model of claim 15, wherein the key is mounted for rotational movement along an axis.

17. The surgical model of claim 16, wherein the block is mounted for rotational movement along a longitudinal axis transverse to the axis.

18. The surgical model of claim 15, wherein the key includes a first edge which is registered with the ridge when the key is in the first position, and a second edge which is inboard of the ridge when the key is in the second position.

19. The surgical model of claim 15, wherein the block includes a first side having a first confrontation surface and a second side having a second confrontation surface, wherein the second confrontation surface is recessed with respect to the first confrontation surface.

20. The surgical model of claim 15, wherein the block terminates in a knob outside of the second body.
